(19) United States
(12) Patent Application Publication
(10) Pub. No.: US 2025/0245847 A1
(43) Pub. Date: Jul. 31, 2025

(54) SYSTEMS AND METHODS FOR MEASUREMENT AND CONTROL OF SPRAYED LIQUID COVERAGE ON PLANT SURFACES

(71) Applicant: AgZen Inc., Somerville, MA (US)

(72) Inventors: Vishnu Jayaprakash, Somerville, MA (US); Kripa Kiran Varanasi, Lexington, MA (US)

(21) Appl. No.: 19/039,502

(22) Filed: Jan. 28, 2025

Related U.S. Application Data
(60) Provisional application No. 63/626,464, filed on Jan. 29, 2024.

(51) Int. Cl. G06T 7/62; A01C 23/04; G06T 7/12; G06T 7/194; G06V 10/24; G06V 10/25; G06V 10/74; G06V 10/764

(52) U.S. Cl. CPC G06T 7/62; A01C 23/047; G06T 7/12; G06T 7/194; G06V 10/24; G06V 10/25; G06V 10/761; G06V 10/764

(57) ABSTRACT

Presented herein are systems and methods for automatically quantifying liquid coverage on exposed plant surfaces (e.g., leaves).

### CROSS REFERENCE TO RELATED APPLICATIONS

This application claims the benefit of U.S. Provisional Patent Application No. 63/626,464, filed Jan. 29, 2024, the texts of which are incorporated herein by reference in its entirety. Moreover, all publications mentioned herein are incorporated by reference herein in their entireties.

### FIELD

This invention relates generally to agricultural systems and methods. More particularly, in certain embodiments, the invention relates to systems and methods for quantifying and enhancing coverage and retention of liquid solutions sprayed onto plant surfaces.

### BACKGROUND

Pesticide pollution is linked to acute illnesses such as cancer, neurological conditions, and birth defects. Furthermore, excess pesticides adversely affect soil chemistry and cause the death of non-target organisms, damaging soil microbiomes responsible for replenishing plant nutrients. Moreover, pesticides represent a major financial burden for farmers, for example, making up about 30% of the total production costs for crops such as cotton. Thus, it is important to improve the efficiency of pesticide application to reduce the amount of pesticide used while achieving efficacious pest control.

Agrochemicals such as pesticides, foliar fertilizer, and nutrient formulations are usually applied to plants in liquid solutions using pressure-controlled spray systems. Foliar solutions (foliar fertilizers) and pesticide solutions are applied directly to the surface of plants (e.g., a surface of a leaf, a surface of a root, a surface of a fruit, a surface of a vegetable, or a surface of a flower of the plant) as opposed to being put in the soil. In such agrochemical spray systems, pressurized pesticide solutions and/or foliar solutions are forced through nozzles at specific flow rates to achieve spray patterns that cover leaves or other plant surfaces with a significant number of droplets. For pesticide sprays to be efficacious in controlling pests and for foliar solutions to be efficacious as fertilizer, it is critical to achieve a high degree of liquid coverage (e.g., droplets, films, and/or pools of liquid) and liquid retention on target plant surfaces.

In order to maximize the efficiency of agrochemical sprays and achieve adequate liquid coverage, there are several parameters that operators can control and optimize. These parameters include the speed at which the sprayer moves through the field, the operational pressure of the spray system, the nozzle design (which impacts both the spray pattern and the droplet size distribution), the nozzle position relative to both the target plant surface and other nozzles, and the chemistry of the applied product. Each of these parameters can have a significant impact on spray characteristics, which can in turn influence pest outcomes and crop yield.

While spray applicators are tasked with carefully optimizing these interdependent parameters to achieve optimal pest control, applicators cannot estimate the effectiveness of a given spray application directly in real time. For example, tools available to farmers are not able to quantify liquid coverage on plant surfaces. Without such tools, farmers are forced to run season-long or year-long experiments to determine whether a certain set of parameters can lead to efficient pest control and the desired yield. The inability to monitor liquid coverage directly on crops also reduces the efficiency of spray applications under changing environmental and crop conditions. For example, a certain set of parameters that results in optimal liquid coverage when wind speeds are negligible could be much less efficient when on-field wind speeds increase to as little as 2-3 mph.

In addition to making pesticide and foliar fertilizer spraying more efficient, the ability to monitor liquid coverage directly on plants could have broader implications on pesticide and foliar fertilizer use in general. For example, currently, farms are advised to apply pesticides at a specific rate per acre as specified by the pesticide label. These rates are determined by field testing of pesticides under standard conditions in small acreage plots. However, a recommended application rate per acre does not account for variability in application efficiency on plants or the impact of variations in environmental and crop conditions on different fields. The ability to monitor coverage on leaves and other plant surfaces could allow farms to move away from application rates per acre and move towards more relevant metrics such as application rates for a given area of the target plant surface, e.g., the leaf area.

### SUMMARY

Presented herein are systems, methods, and devices for measurement and control of liquid solutions sprayed onto plant surfaces.

In one aspect, the present disclosure is directed to a system for automatically quantifying liquid coverage on exposed plant surfaces (e.g., leaves), the system comprising: a processor of a computing device; and a memory having instructions stored thereon, wherein the instructions, when executed by the processor, cause the processor to: receive an image comprising a region of interest corresponding to one or more plant surfaces (e.g., leaves); automatically identify one or more portions of the region of interest corresponding to liquid (e.g., a sprayed-on liquid); and automatically determine a liquid coverage value for the region of interest in the image, wherein the liquid coverage value quantifies (i) an area of the plant surfaces (e.g., leaves) depicted in the region of interest that is covered by liquid and/or (ii) a volume of liquid covering the plant surfaces (e.g., leaves), wherein the instructions, when executed by the processor, cause the processor to automatically identify the liquid coverage value for the plant surfaces using output of a segmentation module (e.g., a leaf identification module and/or a multi-object segmentation module).

In certain embodiments, the instructions, when executed by the processor, cause the processor to automatically identify the liquid coverage value for the plant surfaces using (i) one or more pre-spray images corresponding to a field of view comprising the one or more plant surfaces prior to spraying with a liquid, and (ii) one or more post-spray images corresponding to the field of view comprising the one or more plant surfaces after spraying with the liquid.

In certain embodiments, the instructions, when executed by the processor, cause the processor to (i) identify leaf areas from a pre-spray image (e.g., of a pre-image video stream) and a post-spray image (e.g., of a post-image video stream) using the segmentation module, (ii) match a pair of leaves as segmented (e.g., identified) in the pre-spray image and the post-spray image that correspond to the same leaf, and (iii) use the matched pair of leaves to spatially align (e.g., adjusting a zoom, angle, displacement, and/or the like) the pre-spray image and the post-spray image, after which the liquid coverage value for the region of interest is automatically determined.

In certain embodiments, the instructions, when executed by the processor, cause the processor to (i) segment (e.g., identify) multiple types of objects in pre-spray images of a pre-spray video stream and post-spray images of a post-spray video stream using the segmentation module, (ii) classify certain segmented objects as leaves (e.g., and/or identify leaf properties) from the pre-spray images and the post-spray images, (iii) use a matching module to find matching pairs of pre-spray images and post-spray images that contain the same leaves, (iv) and use a leaf matching module to match a pair of leaves as segmented in a pre-spray image and post-spray image that correspond to the same leaf, after which the liquid coverage value for the region of interest is automatically determined.

In certain embodiments, the instructions, when executed by the processor, cause the processor to automatically identify the liquid coverage value for the plant surfaces using one or more post-spray images corresponding to a field of view comprising the one or more plant surfaces after spraying with a liquid (e.g., without using pre-spray images from a pre-spray camera, e.g., only using a post-spray camera).

In certain embodiments, the instructions, when executed by the processor, cause the processor to (i) segment (e.g., identify) multiple types of objects in the post-spray images (e.g., from a post-spray video stream) using the segmentation module, and (ii) classify certain segmented objects as leaves (e.g., and/or identify leaf properties) from the post-spray images, after which the liquid coverage value for the region of interest is automatically determined.

In certain embodiments, the liquid on the plant surfaces comprises a sprayed-on solution comprising one or more members selected from the group consisting of water, an adjuvant, an additive, a crop-compatible dye, an agrochemical solution, a liquid solution of a pesticide, a liquid solution of a fertilizer, and a foliar fertilizer.

In certain embodiments, the system further comprises one or more imaging devices and/or sensors for obtaining the image, wherein the one or more imaging devices and/or sensors comprises at least one member of the group consisting of a camera, a digital camera, a camera phone, a thermal imaging device, a night vision camera, a Light Detection and Ranging (LiDAR) device, an electronic image sensor, a charge-coupled device (CCD), an active-pixel sensor (CMOS sensor), a smart image sensor, an intelligent image sensor, a red-green-blue (RGB) camera, and a short-wave infrared (SWIR) camera.

In certain embodiments, the instructions, when executed by the processor, cause the processor to automatically identify a background mask corresponding to non-plant-surface portions of the image, and to apply the background mask to the image, thereby eliminating non-plant surface portions from the second image, and to automatically identify the liquid coverage value for the plant surfaces depicted in the background-eliminated image.

In certain embodiments, the instructions, when executed by the processor, cause the processor to automatically determine a series of liquid coverage values for regions in a sequence of images in real time, as the sequence of images is obtained.

In certain embodiments, the system further comprises a display comprising a display screen and a graphical user interface (GUI), wherein the instructions cause the processor to graphically render the liquid coverage value for viewing by a person via the display.

In certain embodiments, the system further comprises a remote communications module, wherein the instructions cause the processor to communicate the liquid coverage value to a remote computing device using the remote communications module.

In certain embodiments, the instructions, when executed by the processor, cause the processor to use the determined liquid coverage value to automatically determine an adjustment of one or more sprayer system parameters to achieve a desired level of liquid coverage, wherein the one or more sprayer system parameters comprises at least one member selected from the group consisting of a sprayer speed, a nozzle type, a nozzle positioning and/or orientation, a number of nozzles used, a spray pressure, an adjuvant and/or additive rate, an overall flow rate, and a boom orientation and/or height.

In certain embodiments, the system comprises one or more environmental sensors for capturing environmental data corresponding to one or more environmental conditions at a location and at a time the image(s) is/are obtained, and wherein the instructions, when executed by the processor, cause the processor to use the environmental data along with the determined liquid coverage value or values to automatically determine the adjustment of the one or more sprayer system parameters, wherein the one or more environmental sensors comprises one or more sensors selected from the group consisting of a temperature sensor, a humidity sensor, a pressure sensor, a wind sensor, a light sensor, an air quality sensor, a gas sensor, a rainfall sensor, a radiation sensor, and a soil sensor.

In certain embodiments, the instructions, when executed by the processor, cause the processor to automatically determine a series of liquid coverage values for regions of interest in a sequence of images and use the automatically determined values to automatically determine the adjustment of the one or more sprayer system parameters to achieve the desired level of liquid coverage, wherein the instructions cause the processor to automatically implement the determined adjustment(s) in real time via a control system for controlling the one or more sprayer system parameters, thereby operating the sprayer system in real time to improve liquid coverage by accounting for one or more changing conditions.

In certain embodiments, the system further comprises a first camera for obtaining the post-spray image (e.g., obtaining a post-spray video stream) (e.g., wherein the first camera is mounted on a sprayer for spraying the liquid onto the plant surfaces, e.g., wherein the sprayer is mounted on a tractor or other device that moves the sprayer and/or spray over the plant surfaces).

In certain embodiments, the system further comprises a second camera for obtaining a pre-spray image (e.g., obtaining a pre-spray video stream).

In another aspect, the present disclosure is directed to a method for automatically quantifying liquid coverage on exposed plant surfaces (e.g., leaves), the method comprising: receiving, by a processor of a computing device, an image comprising a region of interest corresponding to one or more plant surfaces (e.g., leaves); automatically identifying, by the processor, one or more portions of the region of interest corresponding to liquid (e.g., a sprayed-on liquid), and automatically determining a liquid coverage value for the region of interest in the image, wherein the liquid coverage value quantifies (i) an area of the plant surfaces (e.g., leaves) depicted in the region of interest that is covered by liquid and/or (ii) a volume of liquid covering the plant surfaces (e.g., leaves), wherein automatically identifying the liquid coverage value for the plant surfaces comprises using output of a segmentation module (e.g., a leaf identification module and/or a multi-object segmentation module).

In certain embodiments, automatically identifying the liquid coverage value for the plant surfaces comprises using (i) one or more pre-spray images corresponding to a field of view comprising the one or more plant surfaces prior to spraying with a liquid, and (ii) one or more post-spray images corresponding to the field of view comprising the one or more plant surfaces after spraying with the liquid.

In certain embodiments, automatically identifying the liquid coverage value for the plant surfaces comprises (i) identifying leaf areas from a pre-spray image (e.g., of a pre-image video stream) and a post-spray image (e.g., of a post-image video stream) using the segmentation module, (ii) matching a pair of leaves as segmented (e.g., identified) in the pre-spray image and the post-spray image that correspond to the same leaf, and (iii) using the matched pair of leaves to spatially align (e.g., adjusting a zoom, angle, displacement, and/or the like) the pre-spray image and the post-spray image, after which the liquid coverage value for the region of interest is automatically determined.

In certain embodiments, automatically identifying the liquid coverage value for the plant surfaces comprises (i) segmenting (e.g., identifying) multiple types of objects in pre-spray images of a pre-spray video stream and post-spray images of a post-spray video stream using the segmentation module, (ii) classifying certain segmented objects as leaves (e.g., and/or identify leaf properties) from the pre-spray images and the post-spray images, (iii) use a matching module to find matching pairs of pre-spray images and post-spray images that contain the same leaves, and (iv) using a leaf matching module to match a pair of leaves as segmented in a pre-spray image and post-spray image that correspond to the same leaf, after which the liquid coverage value for the region of interest is automatically determined.

In certain embodiments, the liquid coverage value for the plant surfaces is automatically determined using one or more post-spray images corresponding to a field of view comprising the one or more plant surfaces after spraying with a liquid (e.g., without using pre-spray images from a pre-spray camera, e.g., only using a post-spray camera).

In certain embodiments, the liquid coverage value for the plant surfaces is automatically determined by (i) segmenting (e.g., identifying) multiple types of objects in the post-spray images (e.g., from a post-spray video stream) using the segmentation module, and (ii) classifying certain segmented objects as leaves (e.g., and/or identify leaf properties) from the post-spray images, after which the liquid coverage value for the region of interest is automatically determined.

In certain embodiments, the system includes a multi-object segmentation module trained to: (1) perform a first segmentation process that segments the received image into plant and non-plant surfaces; (2) mask the non-plant surfaces; and (3) perform a second segmentation process that further segments an unmasked portion of the received image into sprayed and non-sprayed segments.

In certain embodiments, the multi-object segmentation module includes a convolutional neural network (CNN).

### BRIEF DESCRIPTION OF THE DRAWINGS

The foregoing and other objects, aspects, features, and advantages of the present disclosure will become more apparent and better understood by referring to the following description taken in conjunction with the accompanying drawings, in which:

FIG. 1 is a picture of a system that includes pre and post-spray cameras mounted on a sprayer, according to the present disclosure.

FIG. 2 is a flow diagram showing an implementation of the software for a method of measuring the coverage of spray on the leaves of plants using both a pre-spray image and post-spray image, according to the present disclosure.

FIG. 3 is a flow diagram showing how an implementation of the software for a method of measuring the coverage of spray on the leaves of plants using both a pre-spray image and post-spray image, according to the present disclosure.

FIG. 4 is a picture of the real coverage system requiring only a single post camera mounted on a sprayer, according to the present disclosure.

FIG. 5 is a flow diagram showing an implementation of the software for a single post-spray camera measuring the coverage of spray on the leaves of plants, according to the present disclosure.

FIG. 6 is a schematic showing an implementation of a network environment for use in providing systems, methods, and architectures as described herein, according to an illustrative embodiment.

FIG. 7 is a schematic showing exemplary computing devices that can be used to implement the techniques described, according to an illustrative embodiment.

### DETAILED DESCRIPTION OF THE DISCLOSURE

It is contemplated that systems, architectures, devices, methods, and processes of the present claims encompass variations and adaptations developed using information from the embodiments described herein. Adaptation and/or modification of the systems, architectures, devices, methods, and processes described herein may be performed, as contemplated by this description.

Throughout the description, where articles, devices, systems, and architectures are described as having, including, or comprising specific components, or where processes and methods are described as having, including, or comprising specific steps, it is contemplated that, additionally, there are articles, devices, systems, and architectures of the present disclosure that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

The mention herein of any publication is not an admission that the publication serves as prior art with respect to any of the claims presented herein. The Background section may include concepts informed by the embodiments recited in the claims and further described elsewhere in the specification. The discussion of concepts in the Background section is not an admission that the subject matter discussed is prior art.

Documents are incorporated herein by reference as noted. Where there is any discrepancy in the meaning of a particular term, the meaning provided in this document is controlling.

Headers are provided for the convenience of the reader—the presence and/or placement of a header is not intended to limit the scope of the subject matter described herein.

### Illustrative Pre and Post real Coverage Hardware Diagram

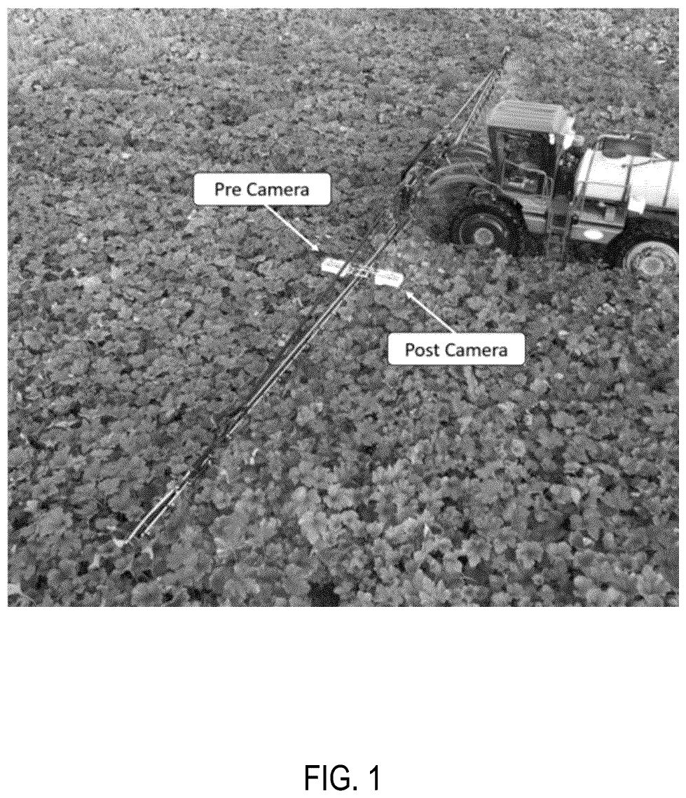

FIG. 1 is an example of system including pre and post-spray cameras mounted on a sprayer. In this example, a pre camera is used to capture all images of leaves and plants before the spray nozzle has passed over the plant, and a post camera is used to capture all images of the same leaves and plants after the spray nozzle has passed and deposited the spray.

### Illustrative Pre and Post Real Coverage Flow Diagram Example 1

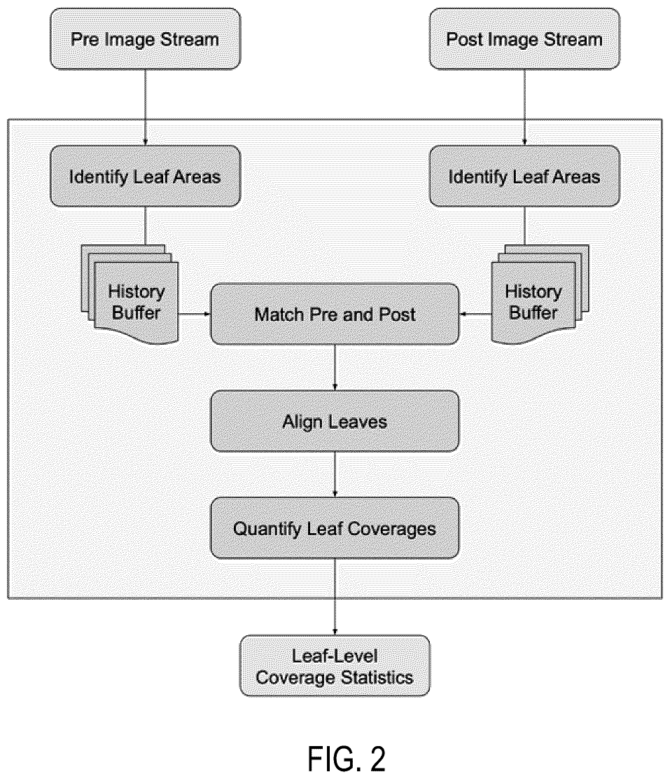

Described herein is an example of how the software could be implemented for a method to measure the coverage of spray on the leaves of plants using both a pre-spray image and post-spray image. In this example, there is a live image stream from a pre-spray camera and a live image stream from a post-spray camera (FIG. 2). A leaf identification module is used to segment all leaves from both the pre images and the post images, separately. These leaves are then stored in a history buffer for later use. A matching module is then used to find the matching pairs of leaves from the set of pre images and post images. A pair of leaves is then spatially aligned (to adjust for zoom, angle, etc.). The coverage and properties of spray on the leaf are then calculated using both the pre and post images of each leaf.

### Illustrative Pre and Post Real Coverage Flow Diagram Example 2

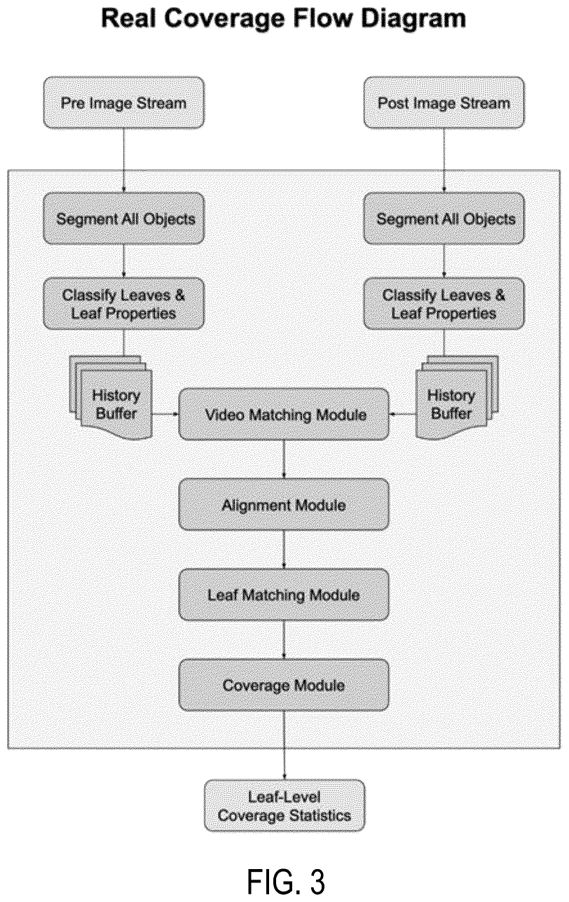

FIG. 3 describes another example of how the software could be implemented for a method to measure the coverage of spray on the leaves of plants using both a pre-spray image and post-spray image. In this example, there is a live image stream from a pre-spray camera and a live image stream from a post-spray camera. First, all images in the pre stream and the post stream are separately segmented into all objects. The objects are then classified to determine if they are a leaf and additional leaf properties are identified. The pre images, post images, and leaves are then stored in two history buffers for later use. A matching module is then used to find the matching pairs of pre and post images that contain the same leaves. An alignment module is used to align the full pre frame with the full post frame. Leaves from the post image are then matched with leaves from the pre image. Finally, the coverage and properties of spray on the leaf are then calculated using both the pre and post images of each leaf.

### Illustrative Single-Camera Real Coverage Hardware Diagram

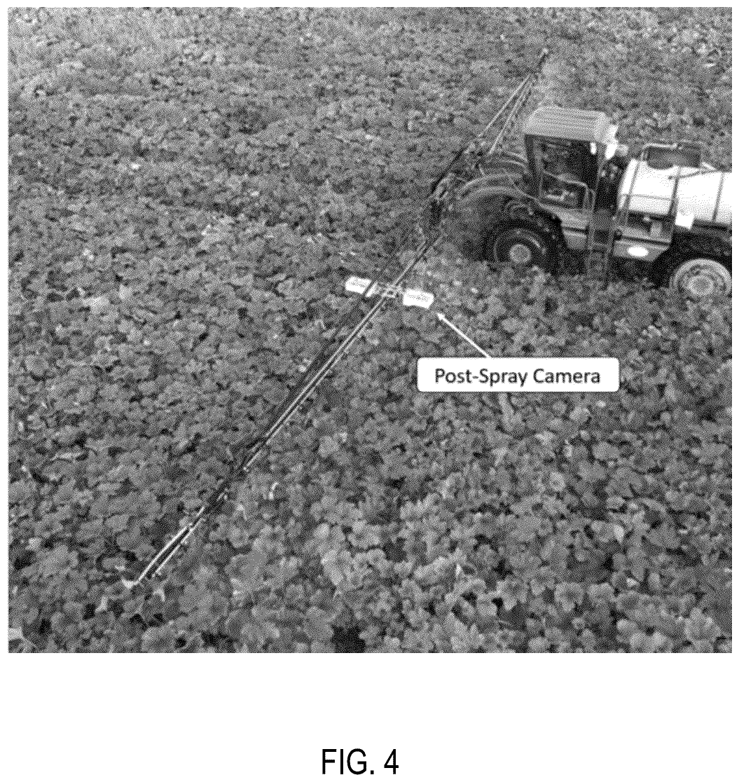

FIG. 4 is an example of the real coverage system requiring only a single post camera mounted on a sprayer. In this example, the post camera is mounted such that it will capture images of leaves and plants only after the spray nozzle has passed and deposited the spray.

### Illustrative Single-Camera Real Coverage Flow Diagram Example 1

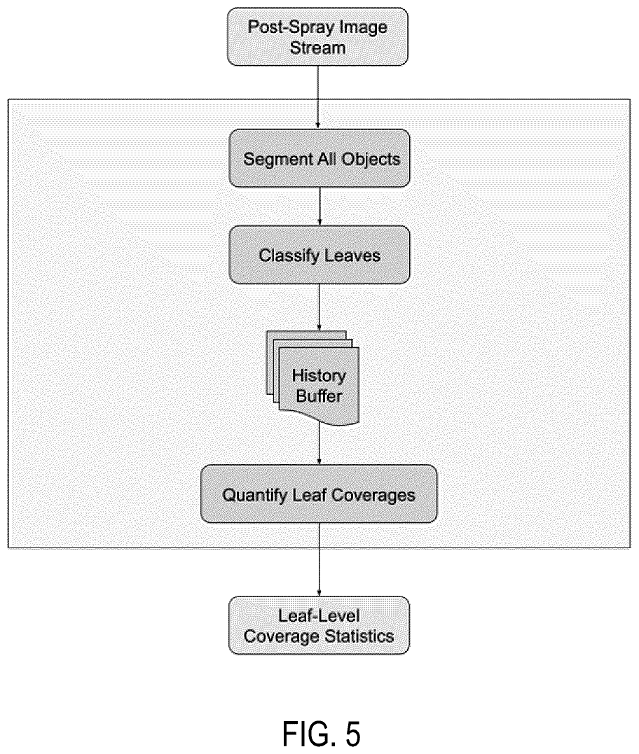

FIG. 5 is an example of how the software could be implemented for a single post-spray camera to measure the coverage of spray on the leaves of plants. In this example, the live image stream of leaves comes from the post-spray camera on the sprayer. First, each image is segmented into all objects (such as leaves, background, etc.). The objects are then classified to determine if they are a leaf or background. A buffer is used to store all valid leaf images for later additional processing. The quantity and properties of the spray coverage is then calculated for each valid leaf. U.S. Patent Application Publication No. US 2023/0367295 published Nov. 16, 2023, and entitled “Systems and Methods for Real-Time Measurement and Control of Sprayed Liquid Coverage on Plant Surfaces” is incorporated herein by reference in its entirety.

### Software, Computer System, and Network Environment

Certain embodiments described herein make use of computer algorithms in the form of software instructions executed by a computer processor. In certain embodiments, the software instructions include a machine learning module, also referred to herein as artificial intelligence (AI) software. As used herein, a machine learning module refers to a computer implemented process (e.g., a software function) that implements one or more specific machine learning techniques, e.g., artificial neural networks (ANNs), e.g., convolutional neural networks (CNNs), random forest, decision trees, support vector machines, and the like, in order to determine, for a given input, one or more output values. In certain embodiments, the input comprises alphanumeric data which can include numbers, words, phrases, or lengthier strings, for example. In certain embodiments, the one or more output values comprise values representing numeric values, words, phrases, or other alphanumeric strings.

For example, in some aspects according to the present disclosure, a segmentation module may be used to assess the liquid coverage value. In some embodiments, the segmentation module employs a CNN. In some embodiments, the CNN convolutes across a received image to identify leaf and non-leaf objects (for example, using edge detection, color differentiation, and/or other techniques as described herein), and thereby establishes one or more boundaries between portions of the image that include plant surfaces (i.e., leaves) and portions of the image that do not include plant surfaces. In some embodiments, the CNN is trained by obtaining one or more control images that include(s) known portions of the image with leaves (i.e., plant surfaces) that have been sprayed and known portions of the image with leaves (i.e., plant surfaces) that have not been spray such that the CNN can correlate visual attributes/patterns of the image (such as color, movement, shapes, edges, etc.) with various characteristics such as leaf vs. non-leaf and sprayed vs. non sprayed. The CNN may similarly be trained using images with known plant and non-plant surfaces. In some embodiments, the segmentation module includes a multi-object segmentation module. For example, a multi-object segmentation module may include using the segmentation module (for example, in connection with a CNN) initially to segment an image into leaf and non-leaf portions (i.e., plant and non-plant surfaces) of the image, and subsequently to further segment the leaf portion (i.e., plant portion) of the image into sprayed and non-sprayed portions of the image. For example, the multi-object segmentation module first masks out portions of the image that include non-plant surfaces, and then segments the plant-surface portion(s) of the image into sprayed and unsprayed segments.

Using a multi-object segmentation module helps to reduce the computational load since the segmentation module is only working to segment sprayed and non-sprayed portions of the image in the “leaf” (or plant) portion of the image (i.e., it won't waste time trying to determine if the non-plant portion(s) of the image has/have been sprayed). In addition, using a multi-object segmentation module helps to improve computation efficiency since, for example, the segmentation module will not waste time trying to identify objects as leaves in portions of the image that do not include leaves. In some embodiments, the segmentation module may also be used to assess temporal changes in the liquid coverage value. For example, an initial liquid coverage value may be determined (i.e., using a CNN and segmentation module) and a subsequent liquid coverage value (for example, following a spraying process) could subsequently be determined via similar means (i.e., using a CNN and segmentation module). In some embodiments, machine learning methodologies (for example, using a recurrent neural network (RNN)) may then be used to identify temporal patterns or sequences of liquid coverage values (i.e., resulting from various spray sequences) thereby presenting opportunities for process improvements and refinements.

In certain embodiments, machine learning modules implementing machine learning techniques are trained, for example using datasets that include categories of data described herein. Such training may be used to determine various parameters of machine learning algorithms implemented by a machine learning module, such as weights associated with layers in neural networks. In certain embodiments, once a machine learning module is trained, e.g., to accomplish a specific task such as identifying certain response strings, values of determined parameters are fixed and the (e.g., unchanging, static) machine learning module is used to process new data (e.g., different from the training data) and accomplish its trained task without further updates to its parameters (e.g., the machine learning module does not receive feedback and/or updates). In certain embodiments, machine learning modules may receive feedback, e.g., based on user review of accuracy, and such feedback may be used as additional training data, to dynamically update the machine learning module. In certain embodiments, two or more machine learning modules may be combined and implemented as a single module and/or a single software application. In certain embodiments, two or more machine learning modules may also be implemented separately, e.g., as separate software applications. A machine learning module may be software and/or hardware. For example, a machine learning module may be implemented entirely as software, or certain functions of an ANN module may be carried out via specialized hardware (e.g., via an application specific integrated circuit (ASIC)).

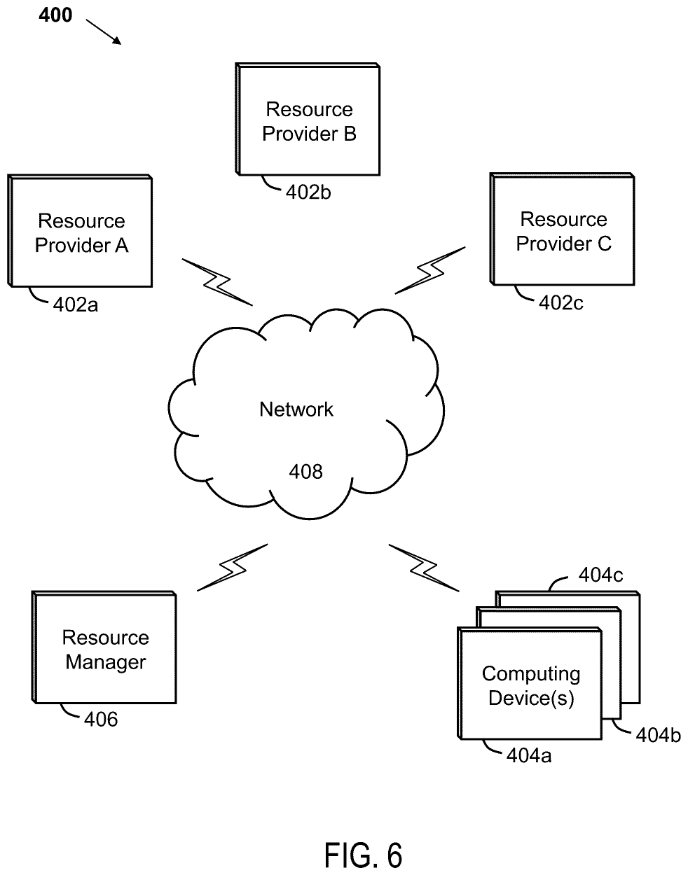

As shown in FIG. 6, an implementation of a network environment 400 for use in providing systems, methods, and architectures as described herein is shown and described. In brief overview, referring now to FIG. 6, a block diagram of an exemplary cloud computing environment 400 is shown and described. The cloud computing environment 400 may include one or more resource providers 402a, 402b, 402c (collectively, 402). Each resource provider 402 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 402 may be connected to any other resource provider 402 in the cloud computing environment 400. In some implementations, the resource providers 402 may be connected over a computer network 408. Each resource provider 402 may be connected to one or more computing device 404a, 404b, 404c (collectively, 404), over the computer network 408.

The cloud computing environment 400 may include a resource manager 406. The resource manager 406 may be connected to the resource providers 402 and the computing devices 404 over the computer network 408. In some implementations, the resource manager 406 may facilitate the provision of computing resources by one or more resource providers 402 to one or more computing devices 404. The resource manager 406 may receive a request for a computing resource from a particular computing device 404. The resource manager 406 may identify one or more resource providers 402 capable of providing the computing resource requested by the computing device 404. The resource manager 406 may select a resource provider 402 to provide the computing resource. The resource manager 406 may facilitate a connection between the resource provider 402 and a particular computing device 404. In some implementations, the resource manager 406 may establish a connection between a particular resource provider 402 and a particular computing device 404. In some implementations, the resource manager 406 may redirect a particular computing device 404 to a particular resource provider 402 with the requested computing resource.

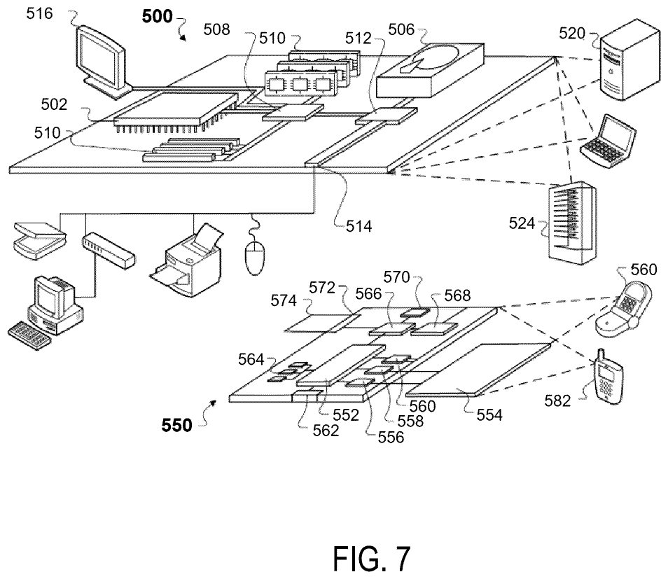

FIG. 7 shows an example of a computing device 500 and a mobile computing device 550 that can be used to implement the techniques described in this disclosure. The computing device 500 is intended to represent various forms of digital computers, such as laptops, desktops, workstations, personal digital assistants, servers, blade servers, mainframes, and other appropriate computers. The mobile computing device 550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system). Thus, as the term is used herein, where a plurality of functions are described as being performed by “a processor”, this encompasses embodiments wherein the plurality of functions are performed by any number of processors (one or more) of any number of computing devices (one or more). Furthermore, where a function is described as being performed by “a processor”, this encompasses embodiments wherein the function is performed by any number of processors (one or more) of any number of computing devices (one or more) (e.g., in a distributed computing system).

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 502), perform one or more methods, such as those described above. The instructions can also be stored by one or more storage devices such as computer-or machine-readable mediums (for example, the memory 504, the storage device 506, or memory on the processor 502).

The high-speed interface 508 manages bandwidth-intensive operations for the computing device 500, while the low-speed interface 512 manages lower bandwidth-intensive operations. Such allocation of functions is an example only. In some implementations, the high-speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device (not shown), such as a mobile computing device 550. Each of such devices may contain one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 568, among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550, or may also store applications or other information for the mobile computing device 550. Specifically, the expansion memory 574 may include instructions to carry out or supplement the processes described above, and may include secure information also. Thus, for example, the expansion memory 574 may be provide as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or NVRAM memory (non-volatile random-access memory), as discussed below. In some implementations, instructions are stored in an information carrier. The instructions, when executed by one or more processing devices (for example, processor 552), perform one or more methods, such as those described above. The instructions can also be stored by one or more storage devices, such as one or more computer-or machine-readable mediums (for example, the memory 564, the expansion memory 574, or memory on the processor 552). In some implementations, the instructions can be received in a propagated signal, for example, over the transceiver 568 or the external interface 562.

The mobile computing device 550 may communicate wirelessly through the communication interface 566, which may include digital signal processing circuitry where necessary. The communication interface 566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 568 using a radio-frequency. In addition, short-range communication may occur, such as using a Bluetooth®, Wi-Fi™, or other such transceiver (not shown). In addition, a GPS (Global Positioning System) receiver module 570 may provide additional navigation-and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, etc.) and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, certain modules described herein can be separated, combined or incorporated into single or combined modules. Any modules depicted in the figures are not intended to limit the systems described herein to the software architectures shown therein.

Elements of different implementations described herein may be combined to form other implementations not specifically set forth above. Elements may be left out of the processes, computer programs, databases, etc. described herein without adversely affecting their operation. In addition, the logic flows depicted in the figures do not require the particular order shown, or sequential order, to achieve desirable results. Various separate elements may be combined into one or more individual elements to perform the functions described herein.

While the present embodiments have been particularly shown and described with reference to specific preferred embodiments, it should be understood by those skilled in the art that various changes in form and detail may be made therein without departing from the spirit and scope of the present disclosure as defined by the appended claims.

What is claimed is:

1. A system for automatically quantifying liquid coverage on exposed plant surfaces, the system comprising:
a processor of a computing device; and
a memory having instructions stored thereon, wherein the instructions, when executed by the processor, cause the processor to:
receive an image comprising a region of interest corresponding to one or more plant surfaces;
automatically identify one or more portions of the region of interest corresponding to liquid; and
automatically determine a liquid coverage value for the region of interest in the image, wherein the liquid coverage value quantifies (i) an area of the plant surfaces depicted in the region of interest that is covered by liquid and/or (ii) a volume of liquid covering the plant surfaces,
wherein the instructions, when executed by the processor, cause the processor to automatically identify the liquid coverage value for the plant surfaces using output of a segmentation module.

2. The system of claim 1, wherein the instructions, when executed by the processor, cause the processor to automatically identify the liquid coverage value for the plant surfaces using (i) one or more pre-spray images corresponding to a field of view comprising the one or more plant surfaces prior to spraying with a liquid, and (ii) one or more post-spray images corresponding to the field of view comprising the one or more plant surfaces after spraying with the liquid.

3. The system of claim 2, wherein the instructions, when executed by the processor, cause the processor to (i) identify leaf areas from a pre-spray image and a post-spray image using the segmentation module, (ii) match a pair of leaves as segmented in the pre-spray image and the post-spray image that correspond to the same leaf, and (iii) use the matched pair of leaves to spatially align the pre-spray image and the post-spray image, after which the liquid coverage value for the region of interest is automatically determined.

4. The system of claim 2, wherein the instructions, when executed by the processor, cause the processor to (i) segment multiple types of objects in pre-spray images of a pre-spray video stream and post-spray images of a post-spray video stream using the segmentation module, (ii) classify certain segmented objects as leaves from the pre-spray images and the post-spray images, (iii) use a matching module to find matching pairs of pre-spray images and post-spray images that contain the same leaves, (iv) and use a leaf matching module to match a pair of leaves as segmented in a pre-spray image and post-spray image that correspond to the same leaf, after which the liquid coverage value for the region of interest is automatically determined.

5. The system of claim 1, wherein the instructions, when executed by the processor, cause the processor to automatically identify the liquid coverage value for the plant surfaces using one or more post-spray images corresponding to a field of view comprising the one or more plant surfaces after spraying with a liquid.

6. The system of claim 5, wherein the instructions, when executed by the processor, cause the processor to automatically identify the liquid coverage value using no pre-spray images from a pre-spray camera.

7. The system of claim 5, wherein the instructions, when executed by the processor, cause the processor to (i) segment multiple types of objects in the post-spray images using the segmentation module, and (ii) classify certain segmented objects as leaves from the post-spray images, after which the liquid coverage value for the region of interest is automatically determined.

8. The system of claim 1, wherein the liquid on the plant surfaces comprises a sprayed-on solution comprising one or more members selected from the group consisting of water, an adjuvant, an additive, a crop-compatible dye, an agrochemical solution, a liquid solution of a pesticide, a liquid solution of a fertilizer, and a foliar fertilizer.

9. The system of claim 1, further comprising one or more imaging devices and/or sensors for obtaining the image, wherein the one or more imaging devices and/or sensors comprises at least one member of the group consisting of a camera, a digital camera, a camera phone, a thermal imaging device, a night vision camera, a Light Detection and Ranging (LiDAR) device, an electronic image sensor, a charge-coupled device (CCD), an active-pixel sensor (CMOS sensor), a smart image sensor, an intelligent image sensor, a red-green-blue (RGB) camera, and a short-wave infrared (SWIR) camera.

10. The system of claim 1, wherein the instructions, when executed by the processor, cause the processor to automatically identify a background mask corresponding to non-plant-surface portions of the image, and to apply the background mask to the image, thereby eliminating non-plant surface portions from the second image, and to automatically identify the liquid coverage value for the plant surfaces depicted in the background-eliminated image.

11. The system of claim 1, wherein the instructions, when executed by the processor, cause the processor to automatically determine a series of liquid coverage values for regions in a sequence of images in real time, as the sequence of images is obtained.

12. The system of claim 1, the system further comprising:
a display comprising a display screen and a graphical user interface (GUI), wherein the instructions cause the processor to graphically render the liquid coverage value for viewing by a person via the display.

13. The system of claim 1, the system further comprising:
a remote communications module, wherein the instructions cause the processor to communicate the liquid coverage value to a remote computing device using the remote communications module.

14. The system of claim 1, wherein the instructions, when executed by the processor, cause the processor to use the determined liquid coverage value to automatically determine an adjustment of one or more sprayer system parameters to achieve a desired level of liquid coverage, wherein the one or more sprayer system parameters comprises at least one member selected from the group consisting of a sprayer speed, a nozzle type, a nozzle positioning and/or orientation, a number of nozzles used, a spray pressure, an adjuvant and/or additive rate, an overall flow rate, and a boom orientation and/or height.

15. The system of claim 14, wherein the system comprises one or more environmental sensors for capturing environmental data corresponding to one or more environmental conditions at a location and at a time the image(s) is/are obtained, and
wherein the instructions, when executed by the processor, cause the processor to use the environmental data along with the determined liquid coverage value or values to automatically determine the adjustment of the one or more sprayer system parameters, wherein the one or more environmental sensors comprises one or more sensors selected from the group consisting of a temperature sensor, a humidity sensor, a pressure sensor, a wind sensor, a light sensor, an air quality sensor, a gas sensor, a rainfall sensor, a radiation sensor, and a soil sensor.

16. The system of claim 1, wherein the instructions, when executed by the processor, cause the processor to automatically determine a series of liquid coverage values for regions of interest in a sequence of images and use the automatically determined values to automatically determine the adjustment of the one or more sprayer system parameters to achieve the desired level of liquid coverage, wherein the instructions cause the processor to automatically implement the determined adjustment(s) in real time via a control system for controlling the one or more sprayer system parameters, thereby operating the sprayer system in real time to improve liquid coverage by accounting for one or more changing conditions.

17. The system of claim 1, further comprising a first camera for obtaining the post-spray image.

18. The system of claim 17, wherein the first camera is mounted on a sprayer for spraying the liquid onto the plant surfaces, and
wherein the sprayer is mounted on a device or vehicle that moves the sprayer over the plant surfaces.

19. The system of claim 17, further comprising a second camera for obtaining a pre-spray image.

20. The system of claim 1, wherein the segmentation module comprises a leaf identification module and/or a multi-object segmentation module.

21. A method for automatically quantifying liquid coverage on exposed plant surfaces, the method comprising:
receiving, by a processor of a computing device, an image comprising a region of interest corresponding to one or more plant surfaces;
automatically identifying, by the processor, one or more portions of the region of interest corresponding to liquid, and
automatically determining a liquid coverage value for the region of interest in the image, wherein the liquid coverage value quantifies (i) an area of the plant surfaces depicted in the region of interest that is covered by liquid and/or (ii) a volume of liquid covering the plant surfaces, wherein automatically identifying the liquid coverage value for the plant surfaces comprises using output of a segmentation module.

22. The method of claim 21, wherein the segmentation module is a leaf identification module and/or a multi-object segmentation module.

23. The method of claim 21, wherein automatically identifying the liquid coverage value for the plant surfaces comprises using (i) one or more pre-spray images corresponding to a field of view comprising the one or more plant surfaces prior to spraying with a liquid, and (ii) one or more post-spray images corresponding to the field of view comprising the one or more plant surfaces after spraying with the liquid.

24. The method of claim 23, wherein automatically identifying the liquid coverage value for the plant surfaces comprises (i) identifying leaf areas from a pre-spray image and a post-spray image using the segmentation module, (ii) matching a pair of leaves as segmented in the pre-spray image and the post-spray image that correspond to the same leaf, and (iii) using the matched pair of leaves to spatially align the pre-spray image and the post-spray image, after which the liquid coverage value for the region of interest is automatically determined.

25. The method of claim 23, wherein automatically identifying the liquid coverage value for the plant surfaces comprises (i) segmenting multiple types of objects in pre-spray images of a pre-spray video stream and post-spray images of a post-spray video stream using the segmentation module, (ii) classifying certain segmented objects as leaves from the pre-spray images and the post-spray images, (iii) use a matching module to find matching pairs of pre-spray images and post-spray images that contain the same leaves, and (iv) using a leaf matching module to match a pair of leaves as segmented in a pre-spray image and post-spray image that correspond to the same leaf, after which the liquid coverage value for the region of interest is automatically determined.

26. The method of claim 21, wherein the liquid coverage value for the plant surfaces is automatically determined using one or more post-spray images corresponding to a field of view comprising the one or more plant surfaces after spraying with a liquid.

27. The method of claim 26, wherein the liquid coverage value for the plant surfaces is automatically determined by (i) segmenting multiple types of objects in the post-spray images using the segmentation module, and (ii) classifying certain segmented objects as leaves from the post-spray images, after which the liquid coverage value for the region of interest is automatically determined.

28. The system of claim 20, wherein the segmentation model comprises a multi-object segmentation module trained to:
(1) perform a first segmentation process that segments the received image into plant and non-plant surfaces;
(2) mask the non-plant surfaces; and
(3) perform a second segmentation process that further segments an unmasked portion of the received image into sprayed and non-sprayed segments.

29. The system of claim 28, wherein the multi-object segmentation module comprises a convolutional neural network (CNN).
